(19) United States
(12) Patent Application Publication
(10) Pub. No.: US 2008/0244654 A1
(43) Pub. Date: Oct. 2, 2008

(54) System and Method for Providing a Directory of Advertisements

(75) Inventor: Joel Angiolillo, Weston, MA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Laboratories Inc., Waltham, MA (US)

(21) Appl. No.: 11/693,338

(22) Filed: Mar. 29, 2007

(51) Int. Cl. H04N 5/445

(52) U.S. Cl. 725/42

(57) ABSTRACT

Embodiments of the present disclosure are directed to a system and method for providing a directory of advertisements comprising receiving a menu command, outputting a user menu at a display device in response to receiving the menu command, receiving one or more entries based on interactions with the user menu to select an advertisement and corresponding advertisement data, retrieving the advertisement and corresponding advertisement data in response to receiving on one or more entries, and outputting, at the display device, at least one of the retrieved advertisement and the retrieved corresponding advertisement data.

### BACKGROUND INFORMATION

Televisions are extremely popular with consumers. Because of advances in recent technology, television-watching has evolved into a multimedia experience. For example, consumers may now watch TV in high-definition on a large flat-screen with stereo surround sound in the comfort of their homes. The experience is further enhanced by a variety of television commercials and advertisements available to viewers. TV advertisements typically constitute 15-, 30-, and 60-second time slots and occupy approximately 20 minutes of every TV hour. However, viewers have little control, if any, over advertisements watched on TV. At best, sophisticated viewers who have personal video recorders (PVRs), also called digital video recorders (DVRs), for example, may rewind or skip back to repeat a commercial or advertisement. Many viewers have limited capability to search for advertisements. For example, most viewers may search for TV advertisements by merely changing channels and hoping to find a desired commercial. As a result, traditional systems and techniques for viewing and searching TV advertisements are insufficient, especially as commercials and advertisements increase in creativity and entertainment value.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts an illustration of a system architecture, according to an exemplary embodiment of the present disclosure;

FIGS. 2A-2D depict an illustration of a directory of advertisements, according to an exemplary embodiment of the present disclosure;

FIGS. 3A-3E depict an illustration of a directory of advertisements, according to an exemplary embodiment of the present disclosure;

FIGS. 4A-4D depict an illustration of a directory of advertisements, according to an exemplary embodiment of the present disclosure;

FIG. 5 depicts an illustrative flowchart, according to an exemplary embodiment of the present disclosure; and

FIG. 6 depicts an illustrative flowchart, according to an exemplary embodiment of the present disclosure.

### DETAILED DESCRIPTION OF EMBODIMENTS

A system and process of the present disclosure includes various exemplary embodiments for providing a directory of advertisements. As TV commercials and advertisements grow in popularity and entertainment value, traditional techniques are becoming increasingly inadequate for navigating TV commercials and advertisements.

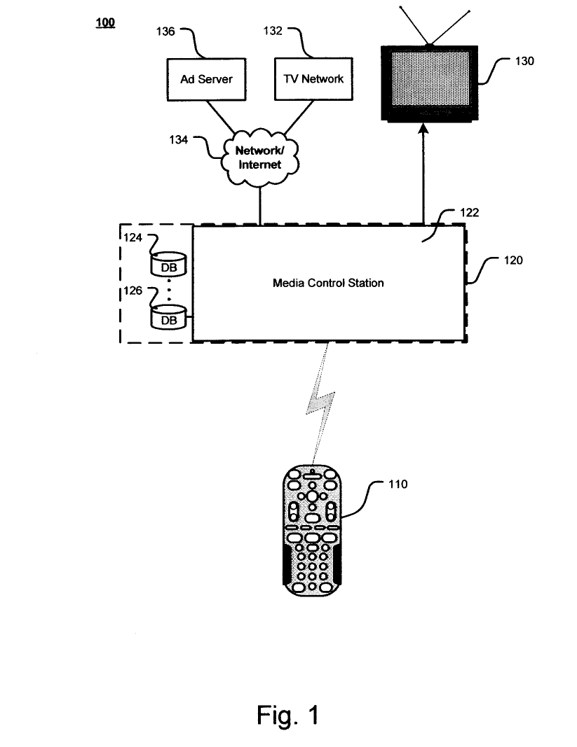

FIG. 1 depicts an illustration of a system architecture, according to an exemplary embodiment of the present disclosure. System 100 may comprise a remote control device 110, a media box 120, and a display device 130. The display device 130 may include a TV, monitor, or other display device. Media box 120 may include a media control station 122 and one or more databases 124, 126. The media control station 122 may include a receiver to receive one or more commands/signals from the remote control device 110, receive a media signal (e.g., streaming media, television programs, etc.) from one or more network providers (e.g., TV network providers 132) via a network/internet 134 (or cable, satellite, etc.), and an output to provide the media signal to display at the display device 130. Ad Server 136 may also be connected to the one or more network providers and the media control station 122 via the network/internet 134. Other variations and components may also be provided, such as a viewer interface, additional inputs/outputs, etc.

The remote control device 110 may transmit and/or receive signals to/from the media box 120. Signal transmission by the remote control device 110 may include a variety of wireless signaling pathways, such as infrared, Bluetooth™, local area wireless network (e.g., 802.11 based protocols), and/or other similar signaling applications. Other various embodiments may also be provided.

It should be appreciated by one of ordinary skill in the art that the remote control device 110 may come in a variety of shapes, sizes, textures, and functionalities with an assortment of buttons and/or labels. Additionally, the remote control device 110 may use various technologies (e.g., wired or wireless technologies) to communicate with external devices. Furthermore, the remote control device 110 may include various playback features, alphanumeric entries/buttons, and other similar functions. It should also be appreciated that other devices having alphanumeric and/or similar remote control capabilities may be used as remote control devices as well. These may include desktop computers, laptops, game controllers, mobile communication devices, such as personal digital assistants (PDAs), mobile phones, smart phones, as well as other devices that may transmit and/or receive signals to/from the media box 120.

Databases 124, 126 may store relevant information received from one or more TV network providers 132. Exemplary database information may include TV network provider information, advertisement categories, advertisers, advertised product/service, TV program channel numbers, TV program channel names, program listings, program schedules for each of the programs, future and past programming information, ratings, and/or other information provided by a TV network provider 132. Although shown as two separate databases, it should be appreciated that the contents of these databases may be combined into fewer or greater numbers of databases and may be stored on one or more data storage systems and/or servers. Furthermore, the databases 124, 126 may be local, remote, or a combination thereof. Additionally, the databases 124, 126 may also store relevant information for personalized subscriber services. These may include user/viewer channel preferences, preferred TV programs/channels, preferred TV viewing times, and other preferred or customized information. Such information may be useful in providing additional customizations for enhanced TV-viewing experience. Other variations may also be provided.

Ad Server 136 may include one or more processors (not shown) for recording and storing data and/or information from the one or more TV network providers 132. The data and/or information may be stored and indexed in one or more databases (not shown) by the one or more processors of the Ad Server 136. In this example, the stored data and/or information may include TV advertisements and corresponding advertisement data provided by TV network providers. In one embodiment, TV advertisements and corresponding advertisement data may be transmitted along with TV programming and guide information. As a result, the Ad Server 136 may utilize processor logic to identify the desired data and/or information to be recorded and stored. In another embodiment, the Ad Server 136 may also include additional processing logic to sort and index the one or more recorded and stored TV advertisements by at least one of the following: category, advertiser, product, title, length of ad, initial broadcast time, ratings, popularity, closed-captioning information. Storing and indexing may be achieved by parsing the advertisement data, which may typically be transmitted as searchable metadata.

In addition to recording, storing, and indexing TV advertisements, the Ad Server 136 may also record and store other data and/or information. In addition to TV advertisements and corresponding advertisement data, these may include a variety of streaming media, such as TV programs (and corresponding program data), music files, and other similar media.

Although the Ad Server 136 is depicted as one server, it should be appreciated that the contents of the Ad Server 136 may be combined into fewer or greater numbers of servers (or server-like devices) and may be connected to one or more data storage systems. Furthermore, the Ad Server 136 may be local, remote, or a combination thereof to the media box 120. The Ad Server 136 may also store additional data and/or information relevant for personalized functionalities. For example, the Ad Server 136 may store data including rebroadcasting rights, rebroadcasting information, advertisement ratings, etc. This data may be used for customizing services provided by or to a TV network provider 132. Additionally, the Ad Server 136 may also customize or personalize subscriber services by recording, storing, and/or indexing additional data/information related to TV advertisements (or other media) by one or more additional subscriber preferences. Other various embodiments may also be provided.

By recording, storing, and/or indexing TV advertisements, as discussed above, many advertisements may be efficiently navigated and one or more desired commercials/advertisements may be quickly located for viewing. Not only does this provide an effective and improved technique for searching and viewing advertisements, it also enhances the overall TV-watching experience. Accordingly, embodiments of the present disclosure may expand the limited number of techniques for searching and viewing TV advertisements by using a directory and/or program guide index to search for advertisements.

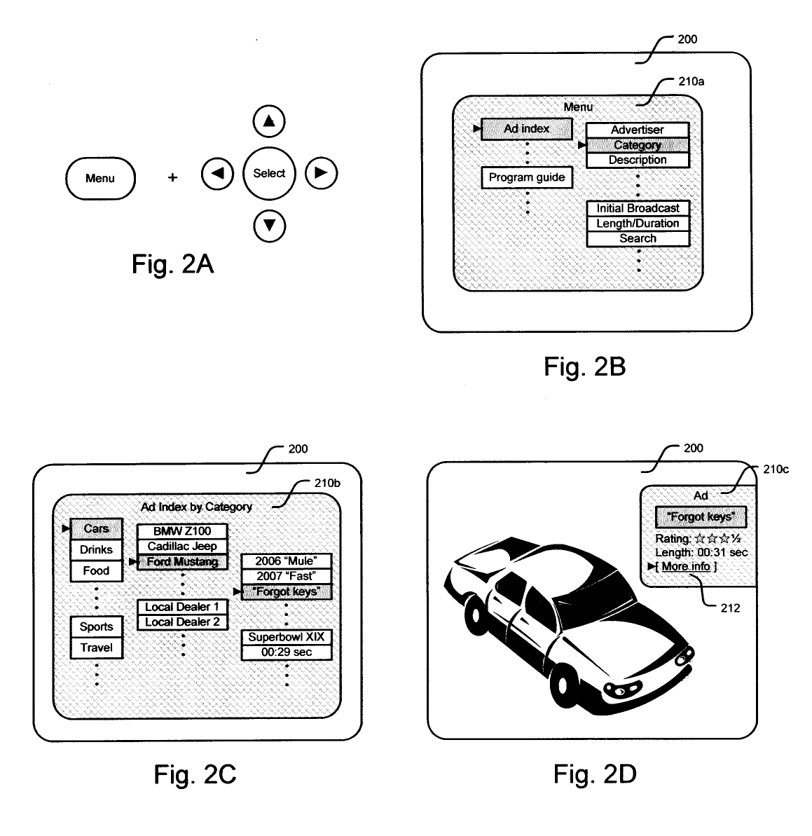

FIGS. 2A-2D depict an illustration of a directory of advertisements, according to an exemplary embodiment of the present disclosure. A user may initiate navigation of TV advertisements by sending a menu command from the remote control device 110 to the media box 120, specifically the media control station 122. Once the media box 120 receives and processes the menu command, the media control station 122 may display an interactive menu of various user options for the user to specify the TV advertisement to view.

In one embodiment, as depicted in FIG. 2A, a user may press a Menu button (or other similar button) on the remote control device 110 to send a menu command to the media box 120. Once the menu command is received, the media box 120 may cause the display device 130 to display a menu 210a of actions for the viewer to choose from, as depicted in FIG. 2B. In this example, the menu 210a may be overlayed or put in the corner of a video broadcast 200, e.g. picture-in-picture (PIP). The menu 210a may provide at least one of an advertisement index (Ad Index) option, a program guide option, and other actions or customizable options. In order to search for TV advertisements, a user may use the remote control device 110 to navigate and select entries. For example, a user may press one or more arrows and a Select button on the remote control device 110 to select the advertisement index option. As depicted in FIG. 2B, once the media box 120 receives these one or more selection entries from the remote control device 110, the menu 210a may provide additional searching features. In this example, the Ad Index option may provide a number of categories to search and/or navigate advertisements. For example, advertisements may be searched by advertiser, category, product, service, description (or summary), initial broadcast date/time, length or duration of the advertisement, an input search function, or other searchable field.

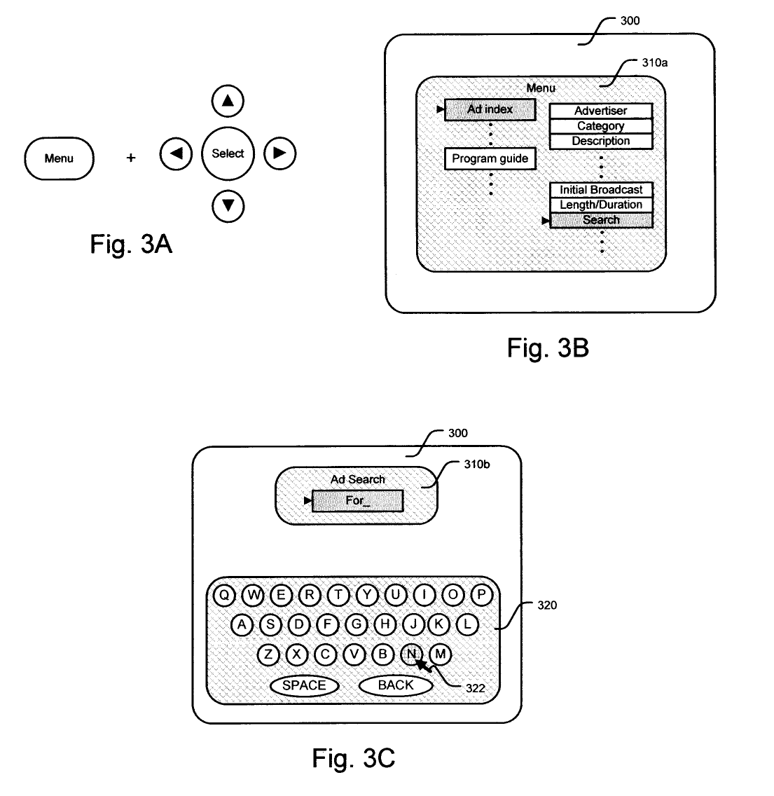

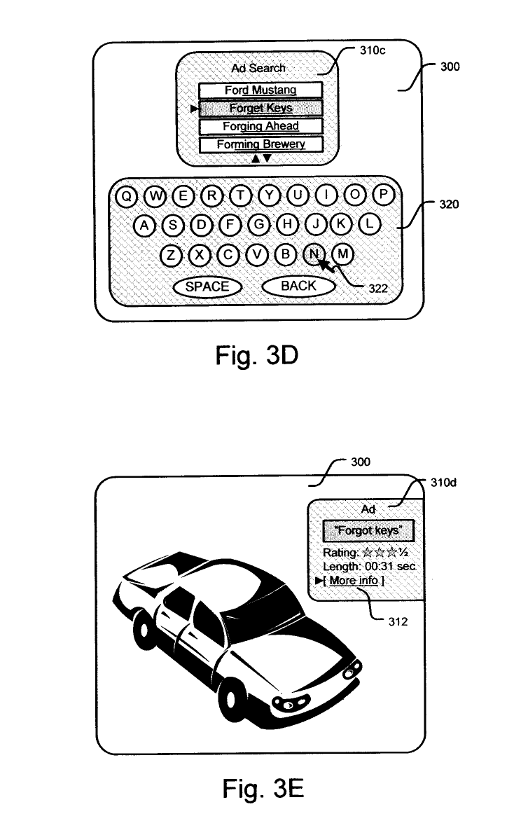

For example, in the event the user elects to search by Category, as depicted in FIG. 2B, the remote control device 110 may send one or more entries to the media box 120 to reflect this selection. Once the Category selection is received and processed by the media control station 122, the media box 120 may cause the Category option to be selected (e.g., by highlight, outline, or other selection indicator). Furthermore, the media box 120 may cause the display device 130 to display another menu 210b, such as Ad Index by Category, as depicted in FIG. 2C. Here, the user may once again press one or more arrows and the Select button to find the desired advertisement to view. At each step of the navigation, the search may narrow. In the example depicted in FIG. 3C, the user may select “Cars” to find a list of various ads that are related to cars. The user may then select “Ford Mustang” from a variety of car options (e.g., other makes, models, dealers, etc.) and be directed to all advertisements related to Ford Mustangs. Here, the user may then proceed to select the desired Ford Mustang advertisement. The list may be indexed by title, product, service, initial broadcast date/time, length/duration of the advertisement, or other indexed category.

Once the user selects the TV advertisement, in this case “Forgot Keys,” the advertisement selection command (based one or more entries) may be sent to the media box 120, which retrieves the selected advertisement from the Ad Server 136, and ultimately causes the display device 130 to display the advertisement on the screen 200, as depicted in FIG. 2D. In one embodiment, a menu box 210c may be displayed over the video broadcast 200 to provide a user with corresponding advertisement information, such as advertisement, title, rating, and length/duration. In another embodiment, a link or selection option, such as “More Info” 212, may also be displayed at the menu box 210c to provide a user with additional advertisement information, such as advertiser, category, initial broadcast date/time, and/or other information provided by the advertisement data from the TV network provider 132. In yet another embodiment, the user may request the advertisement information without watching the advertisement itself. Other various embodiments may also be considered.

It should be appreciated that while the Category field is described above, each of the other menu fields, such as advertiser, product, service, description (or summary), initial broadcast date/time, length or duration of the advertisement, an input search function, or other searchable field, may also function in a similar manner.

It should be appreciated that any of the menus 210a, 210b, 210c may be of varying sizes, shapes, colors, fonts, or other stylistic features, and may be positioned at various locations on the video screen 200. The menus 210a, 210b, 210c may also be personalized or customized to the preferences of different users. Other variations may also be provided.

FIGS. 3A-3E depict an illustration of a directory of advertisements, according to an exemplary embodiment of the present disclosure. A user may initiate navigation of TV advertisements by sending a menu command from the remote control device 110 to the media box 120, specifically the media control station 122. Once the media box 120 receives and processes the menu command, the media control station 122 may display an interactive menu of various user options for the user to specify the TV advertisement to view.

In one embodiment, as depicted in FIG. 3A, a user may press a Menu button (or other similar button) on the remote control device 110 to send a menu command to the media box 120. Once the menu command is received, the media box 120 may cause the display device 130 to display a menu 310a of actions for the viewer to choose from, as depicted in FIG. 2B. In this example, the menu 310a may be overlayed or put in the corner of a video broadcast 200, e.g. picture-in-picture (PIP). The menu 310a may provide at least one of an advertisement index (Ad Index) option, a program guide option, and other actions or customizable options. In order to search for TV advertisements, a user may use the remote control device 110 to navigate and select entries. For example, a user may press one or more arrows and a Select button on the remote control device 110 to select the advertisement index option. As depicted in FIG. 3B, once the media box 120 receives these one or more selection entries from the remote control device 110, the menu 310a may provide additional searching features. In this example, the Ad Index option may provide a number of categories to search and/or navigate advertisements. For example, advertisements may be searched by advertiser, category, product, service, description (or summary), initial broadcast date/time, length or duration of the advertisement, an input search function, or other searchable field.

In the event the user elects to search by Search, as depicted in FIG. 3B, the remote control device 110 may send one or more entries to the media box 120 to enter this selection. Once this selection is received and processed by the media control station 122, the media box 120 may cause the display device 130 to display another menu 310b, such as Ad Search, as depicted in FIG. 3C. Here, the user may be presented with an input field in which to enter one or more alphanumeric entries from the remote control device 110 to spell out and find the desired advertisement to view. In another embodiment, the one or more alphanumeric entries may be entered by using the on-screen keyboard 320 provided by the media control station 122 and displayed on the screen 300. In this example, the user may use on or more arrows on the remote control device 110 to move the on-screen arrow 322 to select letters and/or numbers corresponding to the spelling of the desired advertisement. The user may enter the letters and/or numbers to describe the TV advertisement, such as title, advertiser, product, service, or other searchable field provided by the advertisement data stored at the Ad Server 136 corresponding to each of the one or more advertisements. At each alphanumeric entry of the one or more entries, the search may narrow. In one embodiment, for example, once the media box 120 receives these one or more entries, the Ad Search menu 310b may provide an auto-complete feature to correct for spelling and/or narrow the choice of matching advertisements, as depicted in FIG. 3D. In another embodiment, as depicted in FIG. 3D, the Ad Search menu 310c may provide one or more matching advertisements in a list format for the user to select. Here, the user may proceed to select the desired “Forget Keys” advertisement. In one embodiment, the list may or may not include auto-completed selections. In another embodiment, the list may be indexed by category, title, product, service, initial broadcast date/time, length/duration of the advertisement, or other indexed category.

Once the user selects the TV advertisement, in this case “Forgot Keys,” the advertisement selection command (based one or more entries) may be sent to the media box 120, which retrieves the selected advertisement from the Ad Server 136, and ultimately causes the display device 130 to display the advertisement on the screen 300, as depicted in FIG. 3E, which is similar to FIG. 2D. In one embodiment, a menu box 310d may be displayed over the video broadcast 300 to provide a user with corresponding advertisement information, such as advertisement, title, rating, and length/duration. In another embodiment, a link or selection option, such as “More Info” 312, may also be displayed at the menu box 310d to provide a user with additional advertisement information, such as advertiser, category, initial broadcast date/time, and/or other information provided by the advertisement data from the TV network provider 132. Other various embodiments may also be considered.

It should be appreciated that any of the menus 310a, 310b, 310c, 310d may be of varying sizes, shapes, colors, fonts, or other stylistic features, and may be positioned at various locations on the video screen 300. The menus 310a, 310b, 310c, 310d may also be personalized or customized to the preferences of different users. Other variations may also be provided.

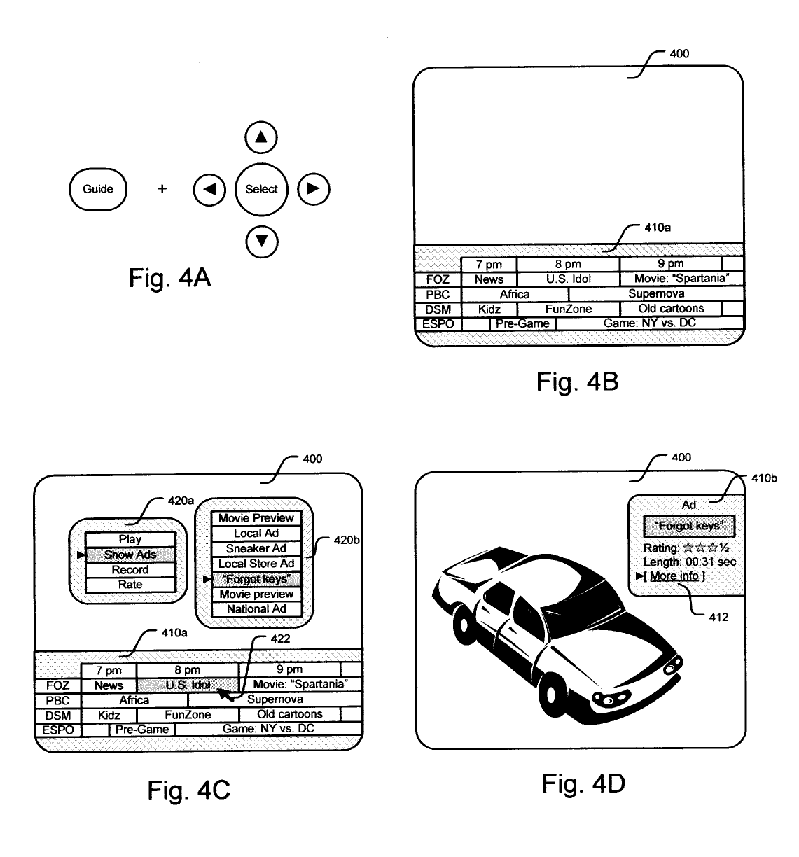

FIGS. 4A-4D depict an illustration of a directory of advertisements, according to an exemplary embodiment of the present disclosure. A user may initiate navigation of TV advertisements by sending a menu command from the remote control device 110 to the media box 120, specifically the media control station 122. Once the media box 120 receives and processes the menu command, the media control station 122 may display an interactive menu of various user options for the user to specify the TV advertisement to view.

In one embodiment, as depicted in FIG. 4A, a user may press a Guide button (or other similar button, e.g., Menu) on the remote control device 110 to send a menu command to the media box 120. Once the menu command is received, the media box 120 may cause the display device 130 to display a program guide menu 410a of actions for the viewer to choose from, as depicted in FIG. 4B. In this example, the program guide menu 410a may be overlayed or put in the bottom or corner of a video broadcast 400, e.g. picture-in-picture (PIP). The program guide menu 410a may provide a listing of TV programs and the date/time each of the TV programs are playing. In this example, in order to search for TV advertisements, a user may use the remote control device 110 to navigate and select entries. For example, a user may press one or more arrows on the remote control device 110 to scroll through the various TV programs and press a Select button (or similar button) to select the desired program. In another embodiment, the user may use a movable on-screen arrow 422 controlled by the keys of the remote control device 110 to select the desired program, as depicted in FIG. 4C.

Once the media box 120 receives these one or more selection entries from the remote control device 110, the media box 120 may provide another program menu 420a to be displayed on the screen 400. The program menu 420a may offer the user several actions or options to choose from, such as Play (to play the selected program), Show Ads (to show a directory of advertisements offered during this particular program), Record (to record the program and/or advertisements in the event the user has PVR or DVR capability), Rate (to rate the program and/or advertisement), or other program/advertisement options.

Once the user selects the action, in this case Show Ads, the one or more entries corresponding to this action may be sent from the remote control device 110 to the media box 120 to process and retrieve information from the advertisement data stored in the Ad Server 136 relating to the advertisements playing in conjunction with the selected program. After receiving this data from the Ad Server 136, the media control station 122 may provide a program advertisement menu 420b, which may list each of the TV advertisements playing during the program. In this example, the user may select and watch an advertisement from the list by using the one or more arrows and the Select button on the remote control device 110. In other words, the user may watch one or more of the advertisements without having to watch the program itself. As a result, the advertisements may be filtered out and selectively viewed by the user. Once the user selects the TV advertisement, in this case “Forgot Keys,” the advertisement selection command (based one or more entries) may be sent to the media box 120, which retrieves the selected advertisement from the Ad Server 136, and ultimately causes the display device 130 to display the advertisement on the screen 400, as depicted in FIG. 4D. In one embodiment, the user may watch only the commercials and advertisements in any customizable order without watching the program. In another embodiment, the user may be able to filter out the programming without watching any of the commercials until after (or before) the desired program. Ultimately, the user may have greater control and flexibility in what is viewed.

In one embodiment, a menu box 410b may be displayed over the video broadcast 400 to provide a user with corresponding advertisement information, such as advertisement, title, rating, and length/duration. In another embodiment, a link or selection option, such as “More Info” 412, may also be displayed at the menu box 410b to provide a user with additional advertisement information, such as advertiser, category, initial broadcast date/time, and/or other information provided by the advertisement data from the TV network provider 132. Other various embodiments may also be considered.

It should be appreciated that any of the menus 410a, 410b, 420a, 420b may be of varying sizes, shapes, colors, fonts, or other stylistic features, and may be positioned at various locations on the video screen 400. The menus 410a, 410b, 420a, 420b may also be personalized or customized to the preferences of different users. Other variations may also be provided.

It should also be appreciated that while embodiments of the present disclosure may be related to retrieving advertisements for past or current programs, a directory of advertisements for future programs may also be provided. This may be achieved when the Ad Server receives advertisement data for advertisements scheduled to be played at a future date and time from the one or more network providers 132. Other various embodiments may also be provided.

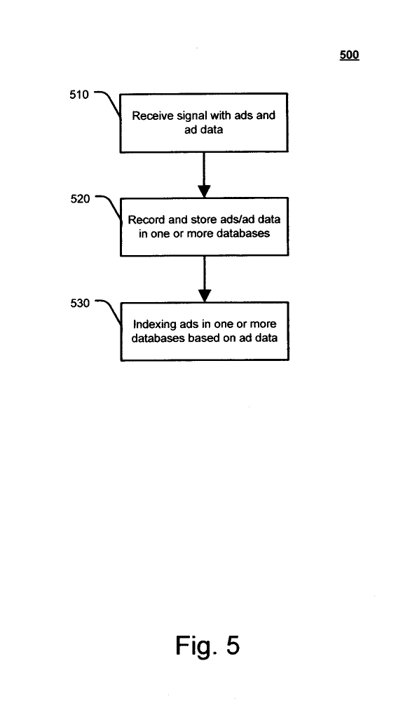

FIG. 5 depicts an illustrative flowchart of a process for indexing advertisements 500, according to an exemplary embodiment of the present disclosure. At step 510, a signal may be received. For example, the Ad Server 136 may receive a signal from a network provider 132, wherein the signal includes one or more advertisements and one or more advertisement data corresponding to each of the one or more advertisements. In one embodiment, the network provider 132 may include a television network provider or other third party. In another embodiment, the network provider 132 may provide other media, such as music, images, etc. In yet another embodiment, the one or more advertisement data may include searchable metadata as provided by the network provider 132 along with the programming. Other variations may also be provided.

At step 520, the one or more advertisements and the corresponding one or more advertisement data may be recorded and stored. For example, the Ad Server 136 may record and store the one or more advertisements and the corresponding one or more advertisement data in one or more databases. The one or more databases may be local, remote, or a combination thereof to the media box 120.

At step 530, the one or more advertisements may be indexed for retrieval. For example, the Ad Server 136 may index the one or more advertisements for retrieval based on the one or more advertisement data in the one or more databases. In one embodiment, indexing the one or more advertisements for retrieval may be based on at least one of category, advertiser, product, service, title, length of ad, initial broadcast time, ratings, popularity, and closed-captioning information. These indexing schemes may be related to the advertisement data corresponding to the one or more retrievable advertisements in the one or more databases.

In another embodiment, the process for indexing advertisements 500 may further include obtaining rights from at least the network provider. These rights may include at least one of rebroadcasting, recording, reproduction, and distribution. Other various embodiments may also be considered.

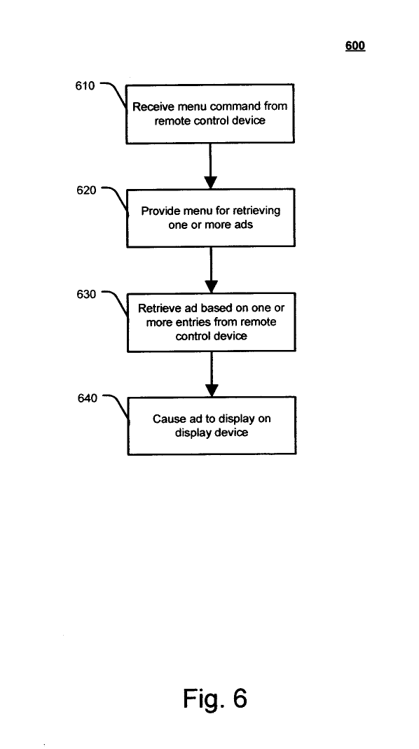

FIG. 6 depicts an illustrative flowchart of a process for retrieving and viewing advertisements 600, according to an exemplary embodiment of the present disclosure. At step 610, a menu command may be received. For example, the media control station 122 may receive a menu command from a remote control device 110. In one embodiment, the user menu may include a program guide menu 410a comprising one or more selectable programs. In this example, each of the one or more programs includes one or more selectable advertisements. In another embodiment, the user menu may include an advertisement index. Here, the advertisement index may include one or more selectable advertisements. The one or more advertisements may be searchable by at least one of category, advertiser, product, service, title, length of ad, initial broadcast time, ratings, popularity, and closed-captioning information. In yet another embodiment, the searchability of the advertisements may relate to the advertisement data corresponding to each of the one or more advertisements stored in the Ad Server 136.

At step 620, a user menu for retrieving one or more advertisements may be provided for display. For example, a processor at the media control station 122 may provide a user menu for retrieving an advertisement in response to the menu command. In one embodiment, the user menu may be provided for display at the display device 130. In another embodiment, the user menu may be interactive and may include at least one of a program guide menu 410a, an ad index, or other similar menu.

At step 630, the advertisement may be retrieved. For example, the media control station 122 may retrieve the advertisement based on one or more entries from the remote control device 110. In this example, the one or more entries may be based on user interactions with the user menu. The media control station 122 may retrieve the advertisement from the Ad Server 136 at one or more databases, which may be local, remote, or a combination thereof to the media box 120. In one embodiment, the one or more entries for retrieving and selecting the desired advertisement may be based on one or more alphanumeric entries from the remote control device 110. In another embodiment, the one or more entries for retrieving and selecting the desired advertisement may be based on one or more entries from an on-screen keyboard 320. Alternatively, in another embodiment, the one or more entries for navigating and selecting the desired advertisement may be based on one or more interactive selector commands from the remote control device 110. In yet another embodiment, the advertisement may be retrieved directly from a TV network provider 132. Other various embodiments may also be provided.

At step 640, the advertisement may be displayed. For example, the media control station 122 may cause a display device to display the advertisement based on the one or more entries. The media control station 122 may further include causing the display device to display an advertisement box over the advertisement, e.g., picture-in-picture (PIP). In this case, the advertisement box may include at least one of the following advertisement information: category, advertiser, product, service, title, length of ad, initial broadcast time, ratings, popularity, closed-captioning information, and advertisement summary. Other various embodiment may also be provided.

It should be appreciated by one skilled in the art that any device capable of transmitting alphanumeric commands may function as a remote control device for the purposes of the embodiments described above. For example, a mobile phone with SMS-capability may send an alphabetic channel-changing SMS to a media box 120, which may include a variety of alphabetical command readers to search/retrieve advertisements from an Ad Server 136. Accordingly, desktops, laptops, and/or mobile communications devices may also serve to provide remote control functionalities. Other various embodiments may also be provided.

While the embodiments described above may be directed to a media box 120, specifically the media control station 122, or an Ad Server 136, to process advertisement features discussed above, it should be appreciated to one of ordinary skill in the art that a remote control device 110, a display device 130, and/or other component may include processing capabilities to perform the features described above as well.

Furthermore, although the embodiments described above are directed toward television programs and advertisements, it may be readily appreciated that one or ordinary skill in the art may apply the features and functionalities discussed above to any video, audio, or web based component, such as computers, communications devices, PVRs or DVRs, multimedia websites/servers, DVDs players, VCRs, CD players, MP3s players, etc. Other various embodiments may also be contemplated.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A method, comprising:
receiving a signal comprising at least one advertisement and corresponding advertisement data for each advertisement;
storing in at least one database each advertisement and corresponding advertisement data; and
indexing each advertisement for retrieval based on the corresponding advertisement data.

2. The method of claim 1, wherein the advertisement data comprises searchable metadata.

3. The method of claim 1, wherein indexing each advertisement for retrieval is based on at least one of category, advertiser, product, title, length of ad, initial broadcast time, ratings, popularity, and closed-captioning information.

4. A computer readable media comprising code to perform the acts of the method of claim 1.

5. A system, comprising:
a media control station; and
a server comprising:
a receiver configured to receive a signal from a network provider, wherein the signal comprises at least one advertisement and corresponding advertisement data for each advertisement;
at least one database configured to store the at least one advertisement and corresponding advertisement data; and
an indexer configured to index the at least one advertisement for retrieval by the media control station based on the corresponding advertisement data.

6. The system of claim 5, wherein the at least one database is local, remote, or a combination thereof to the server.

7. The system of claim 5, wherein the network provider is at least one of a television network provider, a third party data source, or a combination thereof.

8. A method, comprising:
receiving a menu command;
outputting, at a display device, a user menu in response to receiving the menu command;
receiving one or more entries based on interactions with the user menu to select an advertisement and corresponding advertisement data;
retrieving the advertisement and corresponding advertisement data in response to receiving on one or more entries; and
outputting, at the display device, at least one of the retrieved advertisement and the retrieved corresponding advertisement data.

9. The method of claim 8, wherein the user menu is a program guide comprising one or more selectable programs, wherein each of the one or more programs comprises one or more selectable advertisements.

10. The method of claim 8, wherein the user menu is an advertisement index of selectable advertisements.

11. The method of claim 8, wherein the advertisements are retrieved by at least one of category, advertiser, product, title, length of ad, initial broadcast time, ratings, popularity, and closed-captioning information.

12. The method of claim 8, wherein the one or more entries are based on at least one of the following: one or more alphanumeric entries, one or more entries from an on-screen keyboard, and one or more interactive selector commands.

13. The method of claim 8, wherein the method further comprises outputting an advertisement box for display, wherein the advertisement box comprises at least one of the following advertisement information: category, advertiser, product, title, length of ad, initial broadcast time, ratings, popularity, closed-captioning information, and advertisement summary.

14. A computer readable media comprising code to perform the acts of the method of claim 8.

15. A system, comprising:
a receiver configured to receive a menu command from a remote control device;
a processor configured to provide a user menu in response to the menu command and for retrieving an advertisement based on one or more entries from the remote control device, wherein the one or more entries are based on interactions with the user menu; and
an output configured to provide the advertisement for display on a display device based on the one or more entries.

16. The system of claim 15, wherein the advertisement is retrieved from at least one database, wherein the at least one database is local, remote, or a combination thereof to a server storing the at least one advertisement.

17. The system of claim 15, wherein the advertisement is retrieved from a network provider.

18. The system of claim 17, wherein the network provider is at least one of a TV network provider.

19. The system of claim 15, wherein the advertisement further comprises an advertisement data corresponding to the advertisement, wherein the advertisement data comprises searchable metadata.

20. The system of claim 19, wherein the advertisement data is retrieved from a source that is the same as the advertisement source, different from the advertisement source, or a combination thereof.

21. An apparatus, comprising:
a receiver configured to receive a signal from a network provider, wherein the signal comprises at least one advertisement and corresponding advertisement data for each advertisement;
at least one database configured to store the at least one advertisement and corresponding advertisement data; and
an indexer configured to index the at least one advertisement and corresponding advertisement data for retrieval based on the corresponding advertisement data.
an output configured to transmit the at least one retrieved advertisement and corresponding advertisement data.

22. The apparatus of claim 21, wherein the at least one database is local, remote, or a combination thereof to the server.

23. The apparatus of claim 21, wherein the network provider is at least one of a television network provider, a third party data source, or a combination thereof.

24. The apparatus of claim 21, wherein the indexer indexes each advertisement and corresponding advertisement data based on at least one of category, advertiser, product, title, length of ad, initial broadcast time, ratings, popularity, and closed-captioning information.
